(19) United States
(12) Patent Application Publication
(10) Pub. No.: US 2025/0335203 A1
(43) Pub. Date: Oct. 30, 2025

(54) RECONFIGURABLE PROCESSOR AND A METHOD OF IMPROVING AN EFFICIENCY OF THE RECONFIGURABLE PROCESSOR

(71) Applicant: National University of Singapore, Singapore (SG)

(72) Inventors: Yao Zu WONG, Singapore (SG); Viveka KONANDUR RAJANNA, Singapore (SG); Praveenakumar Shivappa SALAMANI, Singapore (SG); Hayate OKUHARA, Singapore (SG); Massimo ALIOTO, Singapore (SG)

(21) Appl. No.: 19/193,344

(22) Filed: Apr. 29, 2025

(30) Foreign Application Priority Data
Apr. 30, 2024 (SG) 10202401255T

(51) Int. Cl. G06F 9/38; G06F 9/30

(52) U.S. Cl. CPC G06F 9/3869; G06F 9/30098

(57) ABSTRACT

A reconfigurable processor is described in an embodiment. The reconfigurable processor comprising a pipelined processor and memory modules associated with the pipelined processor, the pipelined processor being configured to execute an instruction set in a multi-stage pipeline including an instruction fetch (IF) stage, an instruction decode (ID) stage and an execute (EX) stage, wherein the pipelined processor is further adapted to perform each of the IF, ID and EX stages as two or more interleaved threads in a multi-thread mode and to share an IF pipeline output of the IF stage and/or an ID pipeline output of the ID stage between the two or more interleaved threads. A method of improving an efficiency of the reconfigurable processor is also described in an embodiment.

### CROSS-REFERENCE TO RELATED APPLICATIONS

The present application claims the benefit of the filing date of Singapore patent Application No. 10202401255T, filed Apr. 30, 2024, the disclosures of which are incorporated herein by reference.

### TECHNICAL FIELD

The present disclosure relates to a reconfigurable processor and a method of improving an efficiency of the reconfigurable processor.

### BACKGROUND

There has always been a relentless push for computing systems, particularly event-driven edge systems, to improve their energy and area efficiencies for low-power and low-cost applications.

Core clusters to improve energy and area efficiency were demonstrated recently with various levels of reconfigurability. Multi-precision and extended RISC-V instruction sets were explored where instruction memory (IMEM) is shared across processing cores executing the same program on different data for lower energy. In a separate work, tunneling registers were introduced to speed up inter-core communication but with the energy-performance tradeoff scalability unaltered. Yet in another work, the processing element array was reconfigured to operate as multiple RISC-V data paths but with software (SW) stack incompatibility. There remains a need to fill the traditional energy-flexibility gap of processors and accelerators while preserving a SW stack compatibility for software-programmable architectures.

It is therefore desirable to provide a reconfigurable processor and a method of improving an efficiency of the reconfigurable processor which address the aforementioned problems and/or provide a useful alternative. Further, other desirable features and characteristics will become apparent from the subsequent detailed description and the appended claims, taken in conjunction with the accompanying drawings and this background of the disclosure.

### SUMMARY

Aspects of the present application relate to a reconfigurable processor and a method of improving an efficiency of the reconfigurable processor.

In accordance with a first aspect, there is provided a reconfigurable processor comprising: a pipelined processor and memory modules associated with the pipelined processor, the pipelined processor being configured to execute an instruction set in a multi-stage pipeline including an instruction fetch (IF) stage, an instruction decode (ID) stage and an execute (EX) stage, wherein the pipelined processor is further adapted to perform each of the IF, ID and EX stages as two or more interleaved threads in a multi-thread mode and to share an IF pipeline output of the IF stage and/or an ID pipeline output of the ID stage between the two or more interleaved threads.

By having the pipelined processor adapted to perform each of the IF, ID and EX stages as two or more interleaved threads in a multi-thread mode and to share an IF pipeline output of the IF stage and/or an ID pipeline output of the ID stage between the two or more interleaved threads, energy efficiency of the reconfigurable processor is improved as pipeline outputs of the IF stage and/or the ID stage can be shared without expending additional resources or energy for executing the IF stage and/or the ID stage for each of the two or more interleaved threads otherwise.

The reconfigurable processor may comprise bypass registers adapted to allow the pipelined processor to switch between performing the IF, ID and EX stages in a single-thread mode and performing the IF, ID and EX stages in the multi-thread mode.

The reconfigurable processor may comprise: one or more further pipelined processors and further memory modules for each of the one or more further pipelined processors, each of the one or more further pipelined processors being configured to execute the instruction set in a further multi-stage pipeline including a further IF stage, a further ID stage and a further EX stage, wherein the memory modules associated with the pipelined processor include an instruction memory (IMEM) module adapted to share an IMEM output of the pipelined processor with each of the one or more further pipelined processors for use in the further multi-stage pipeline.

The pipelined processor may be adapted to share the IF pipeline output of the IF stage as a further ID input to the further ID stage of each of the one or more further pipelined processors. In this case, energy efficiency of the reconfigurable processor is improved by sharing the IF pipeline output of the pipelined processor with each of the one or more further pipelined processors. Working in tandem with sharing the IMEM output across the pipelined processor and the one or more further pipelined processors when these pipelined processors execute a same program, further energy can be saved.

The pipelined processor may be adapted to share the ID pipeline output of the ID stage as a further EX input to the further EX stage of each of the one or more further pipelined processors. In this case, energy efficiency of the reconfigurable processor is improved by sharing the ID pipeline output of the pipelined processor with each of the one or more further pipelined processors. Working in tandem with sharing the IMEM output across the pipelined processor and the one or more further pipelined processors when these pipelined processors execute a same program, further energy can be saved.

The pipelined processor may be adapted to share the IF pipeline output of the IF stage as a further ID input to the further ID stage of each of the one or more further pipelined processors and to share the ID pipeline output of the ID stage as a further EX input to the further EX stage of each of the one or more further pipelined processors. In this case, energy efficiency of the reconfigurable processor is improved by sharing the IF pipeline output and the ID pipeline output of the pipelined processor with each of the one or more further pipelined processors. Working in tandem with sharing the IMEM output across the pipelined processor and the one or more further pipelined processors when these pipelined processors execute a same program, further energy can be saved.

The reconfigurable processor may comprise systolic registers adapted to transfer data between the pipelined processor and the one or more further pipelined processors. The systolic registers, which may be memory-mapped, reduce energy associated with inter-core and/or intra-core (i.e. between threads of a pipelined processor) communication as regular or systolic outputs from the systolic registers can be transferred with no memory access.

The reconfigurable processor may comprise an arithmetic logic unit (ALU) for each of the one or more further pipelined processors, the ALU being adapted to change a bit precision of a further EX stage output of the further EX stage.

The ALU may be adapted to change the bit precision from 4 bits to 32 bits and vice versa.

The reconfigurable processor may comprise a watchdog unit adapted to monitor the pipelined processor for malfunctions or deadlock conditions.

In accordance with a second aspect, there is provided a method of improving an efficiency of a reconfigurable processor, the reconfigurable processor having a pipelined processor and memory modules associated with the pipelined processor, the pipelined processor being configured to execute an instruction set in a multi-stage pipeline including an instruction fetch (IF) stage, an instruction decode (ID) stage and an execute (EX) stage, the method comprising: performing each of the IF, ID and EX stages as two or more interleaved threads in a multi-thread mode; and sharing an IF pipeline output of the IF stage and/or an ID pipeline output of the ID stage between the two or more interleaved threads.

Wherein the reconfigurable processor comprises bypass registers, the method may comprise using the bypass registers to switch the pipelined processor between performing the IF, ID and EX stages in a single-thread mode and performing the IF, ID and EX stages in the multi-thread mode.

Wherein the reconfigurable processor comprises one or more further pipelined processors and further memory modules for each of the one or more further pipelined processors, each of the one or more further pipelined processors being configured to execute the instruction set in a further multi-stage pipeline including a further IF stage, a further ID stage and a further EX stage, and wherein the memory modules associated with the pipelined processor may include an instruction memory (IMEM) module, the method may comprise: sharing an IMEM output of the IMEM module of the pipelined processor with each of the one or more further pipelined processors for use in the further multi-stage pipeline.

The method may comprise: sharing the IF pipeline output of the IF stage of the pipelined processor as a further ID input to the further ID stage of each of the one or more further pipelined processors.

The method may comprise: sharing the ID pipeline output of the ID stage of the pipelined processor as a further EX input to the further EX stage of each of the one or more further pipelined processors.

The method may comprise: sharing the IF pipeline output of the IF stage of the pipelined processor as a further ID input to the further ID stage of each of the one or more further pipelined processors; and sharing the ID pipeline output of the ID stage of the pipelined processor as a further EX input to the further EX stage of each of the one or more further pipelined processors.

Wherein the reconfigurable processor further comprises systolic registers, the method may comprise transferring data between the pipelined processor and the one or more further pipelined processors using the systolic registers.

Wherein the reconfigurable processor further comprises an arithmetic logic unit (ALU) for each of the one or more further pipelined processors, the method may comprise changing a bit precision of a further EX stage output of the further EX stage using the ALU.

Wherein changing the bit precision of the further EX stage output may comprise changing the bit precision from 4 bits to 32 bits and vice versa.

Wherein the reconfigurable processor further comprises a watchdog unit, the method may comprise monitoring the pipelined processor for malfunctions or deadlock conditions using the watchdog unit.

It should be appreciated that features relating to one aspect may be applicable to the other aspects. Embodiments provide a reconfigurable processor and a method of improving an efficiency of the reconfigurable processor. Particularly, by having the pipelined processor adapted to perform each of the IF, ID and EX stages as two or more interleaved threads in a multi-thread mode and to share an IF pipeline output of the IF stage and/or an ID pipeline output of the ID stage between the two or more interleaved threads, energy efficiency of the reconfigurable processor is improved as outputs of the IF stage and/or the ID stage can be shared without expending additional resources or energy for executing the IF stage and/or the ID stage for each of the two or more interleaved threads. In an embodiment, energy efficiency of the reconfigurable processor can be further improved by sharing the IF pipeline output and/or the ID pipeline output of the pipelined processor with each of the one or more further pipelined processors and working in tandem with sharing the instruction memory output across the pipelined processor and the one or more further pipelined processors when these pipelined processors execute a same program. Further, in an embodiment where the reconfigurable processor comprises systolic registers adapted to transfer data between the pipelined processor and the one or more further pipelined processors, energy associated with inter-core and/or intra-core (i.e. between threads of a pipelined processor) communication can be reduced as regular or systolic outputs from the systolic registers can be transferred with no memory access.

### BRIEF DESCRIPTION OF THE DRAWINGS

Embodiments will now be described, by way of example only, with reference to the following drawings, in which:

FIG. 1 shows a plot of device performance versus energy to illustrate an energy-performance trade-off in edge computing in accordance with an embodiment;

FIG. 2 shows a plot of flexibility versus energy to illustrate a trade-off between flexibility and efficiency of processors in accordance with an embodiment;

FIG. 3 shows a block diagram of a system on chip comprising a reconfigurable processor in accordance with an embodiment;

FIG. 4 shows an illustration of various operations provided by the reconfigurable processor of FIG. 3 in accordance with an embodiment;

FIG. 5 shows a block diagram of a multi-stage pipeline of a primary pipelined processor and a further multi-stage pipeline of a secondary pipelined processor in accordance with an embodiment;

FIG. 6 shows a block diagram illustrating a pipeline flow of the primary pipelined processor and a further pipeline flow of the secondary pipelined processor in accordance with an embodiment;

FIG. 7 shows a schematic of a timing diagram to illustrate pipeline stage execution of the primary pipelined processor and the secondary pipelined processor in accordance with an embodiment;

FIG. 8 is a flowchart of a method of improving an efficiency of the reconfigurable processor of FIG. 3 in accordance with an embodiment;

FIG. 9 shows a plot of frequency versus a supply voltage VDD of the pipelined processors for various operating modes in accordance with an embodiment;

FIG. 10 shows a plot of energy per operation for various operating modes in accordance with an embodiment;

FIGS. 11A, 11B, 11C and 11D show pie charts of a measured power breakdown for various operating modes in accordance with an embodiment, where FIG. 11A shows a pie chart of a measured power breakdown for a dual thread (DT) mode, FIG. 11B shows a pie chart of a measured power breakdown for an intra-core IF/ID sharing (SIMD) mode, FIG. 11C shows a pie chart of a measured power breakdown for an inter-core IMEM sharing (SIMD-MS) mode, and FIG. 11D shows a pie chart of a measured power breakdown for an inter-core IF/ID and IMEM sharing (SIMD+) mode;

FIG. 12 shows a bar chart of measured throughput at 4 bits versus operating temperatures in accordance with an embodiment;

FIG. 13 shows a bar chart of measured core dynamic power versus operating temperatures in accordance with an embodiment; and

FIG. 14 shows a micrograph of the reconfigurable processor used in experiments for obtaining the results shown in relation to FIGS. 9 to 13.

### DETAILED DESCRIPTION

Exemplary embodiments relate to a reconfigurable processor and a method of improving an efficiency of the reconfigurable processor.

It is appreciated that in the present application, the use of the singular includes the plural unless specifically stated otherwise. It should be noted that, as used in the specification and the appended claims, the singular forms “a”, “an” and “the” include plural referents unless the context clearly dictates otherwise. Further, the use of the term “including”, “comprising”, and “having” as well as other forms, such as “include”, “comprise”, “have” are not considered limiting.

As used herein, the term “and/or” includes any and all combinations of one or more of the associated listed items.

As used herein, the term “comprising” or “including” is to be interpreted as specifying the presence of the stated features, integers, steps or components as referred to, but does not preclude the presence or addition of one or more features, integers, steps or components, or groups thereof. However, in context with the present disclosure, the term “comprising” or “including” also includes “consisting of”. The variations of the word “comprising”, such as “comprise” and “comprises”, and “including”, such as “include” and “includes”, have correspondingly varied meanings.

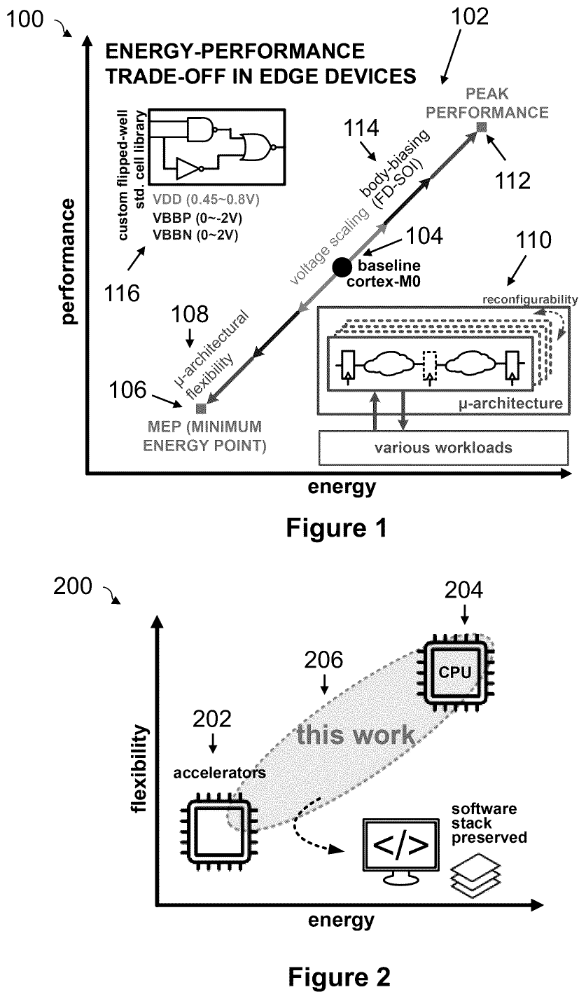

FIG. 1 shows a plot 100 of device performance versus energy to illustrate an energy-performance trade-off in edge computing in accordance with an embodiment.

A simplified trend 102 of device performance versus energy is shown in the plot 100 in relation to different technologies used. Taking for example a baseline having ARM® Cortex®-M0 104 (it should be appreciated that other processor architectures can be used), voltage scaling can be scaled towards the minimum energy point (MEP) 106 via application of micro-architecture (or μ-architecture) 108 which provides flexibility on reconfigurability while lowering performance. An inset 110 showing an example of the μ-architecture 108 which can be adapted for various workloads is provided. On the other hand, peak performance 112 with higher energy expenditure can be achieved, for example via body-biasing using Fully Depleted Silicon-on-Insulator (FD-SOI) 114. Another inset 116 showing an example of a custom flipped-well standard library cell is also provided. The flipped-well standard cell library shown relates to a specific process which favors the FD-SOI as adopted in the present embodiment. The plot 100 illustrates the importance and tradeoffs of energy efficiency for low-power applications (in units of Tera Operations per second per Watt (TOPS/W)) and area efficiency for low-cost applications (in units of Tera Operations per second per area (TOPS/area) where area can be in the unit of mm²).

FIG. 2 shows a plot 200 of flexibility versus energy to illustrate a trade-off between flexibility and efficiency of processors in accordance with an embodiment. As shown in the plot 200, accelerators 202 which include specially designed hardware and/or software computing processors (e.g. graphics processing units (GPUs), application-specific integrated circuits (ASICs) and neural processing units (MPUs) etc.) provide the least flexibility but are the most energy efficiency as they are designed especially for a specific task or application. On the other hand, a generic central processing unit (CPU) offers the most flexibility as it can be used in various applications. However, a generic CPU will be less energy efficiency as compared to an accelerator, as shown in the plot 200. The present work 206 aims to fill the gap between the accelerators 202 and the generic CPU 204 by providing some flexibility with certain energy efficiency, while preserving the same software stack of a single-core instance of the same processor for use with the reconfigurable processor of the present disclosure.

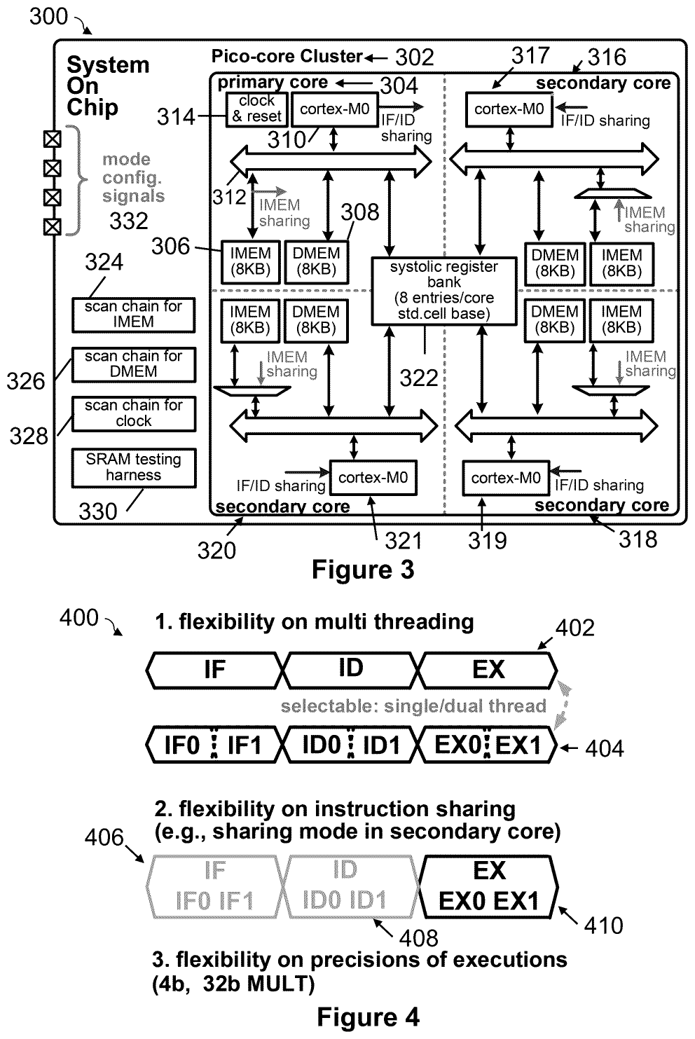

FIG. 3 shows a block diagram of a system on chip 300 comprising a reconfigurable processor 302 in accordance with an embodiment.

The reconfigurable processor 302 (also named as “Pico-core cluster”) in the present embodiment comprises four cores, a primary core 304 and three secondary cores 316, 318, 320. As shown in the present block diagram, the primary core 304 can be considered as a functional unit including memory modules 306, 308 and a pipelined processor 310. The demarcations as shown in FIG. 3 are provided for ease of understanding. The same applies to the secondary cores 316, 318, 320. The primary core 304 and the secondary cores 316, 318, 320 have the same functionality when operating normally, but as will be made clear later, certain flows or portions of the secondary cores may not be required to be executed under one or more of the sharing processes, which allows reduction of energy used in the secondary cores 316, 318, 320.

The memory modules 306, 308 are made available and associated with the pipelined processor 310 of the primary core 304. In the present embodiment, the memory modules 306, 308 include an instruction memory (IMEM) module 306 and a data memory (DMEM) module 308. The IMEM module 306 is adapted to store program instructions or an instruction set for execution by the pipelined processor 310 and the DMEM module 308 is adapted to store and retrieve data used by the pipelined processor 310 during program execution. The pipelined processor 310 is configured to execute an instruction set, for example provided by the IMEM module 306, in a multi-stage pipeline 312 including an instruction fetch (IF) stage, an instruction decode (ID) stage and an execute (EX) stage. In the present embodiment, the pipelined processor 310 includes an ARM® Cortex®-M0 micro-controller, although it should be appreciated that other types of processors may be used. A clock and reset 314 is also shown. The clock and reset 314 is adapted to manage clocks and resets and are shared across the reconfigurable processor 302, common to the primary core 304 and the secondary cores 316, 318, 320.

As shown in FIG. 3, in the present embodiment, one or more further pipelined processors 317, 319 and 321 are also provided. In the present embodiment, the reconfigurable processor 302 includes four pipelined processors 310, 317, 319, 321 with one pipelined processor 310 for the primary core 304 and three secondary pipelined processors 317, 319, 321 for the secondary cores 316, 318, 320. Also shown in FIG. 3 is that each of these secondary cores 316, 318, 320 are similar to the primary core 304 in that there are an instruction memory (IMEM) module and a data memory module made available for each of these secondary cores 316, 318, 320. These components can operate or function in a similar manner to the IMEM module 306 and the DMEM module 308 of the primary core and so these are not described again for succinctness. In the present embodiment, each of the secondary pipelined processors 317, 319, 321 includes an ARM® Cortex®-M0 micro-controller.

In the reconfigurable processor 302 of the present embodiment, there is also provided systolic registers (or a systolic register bank) 322 adapted to transfer data between the primary and secondary pipelined processors 310, 317, 319, 321. The systolic registers 322 can be memory-mapped and are adapted to allow regular/systolic output transfer with no memory access, thereby reducing energy used for inter-core or intra-core communications.

Other components of the system on chip 300 are also shown in FIG. 3 and these include a scan chain for the IMEM modules 324, a scan chain for the DMEM modules 326, a scan chain for the clock 328, and a static random access memory (SRAM) testing harness 330. The system on chip 300 also includes inputs for receiving mode configuration signals 332. The mode configuration signals 332 allow for changing of the operating modes of the reconfigurable processor 302. The mode configuration signals 332 can be received externally, or can be generated on chip by a high-level processing unit.

In the present disclosure, the reconfigurable processor 302 as shown in relation to FIG. 3 can be adapted at various levels for improving its energy and/or area efficiencies. This is described in relation to FIG. 4 below.

FIG. 4 shows an illustration 400 of various operations or operating modes provided by the reconfigurable processor 302 of FIG. 3 in accordance with an embodiment.

At a first level for improving energy and/or area efficiencies, the primary pipelined processor 310 and/or the secondary pipelined processors 317, 319, 321 can be adapted to perform each of the IF, ID and EX stages as two or more interleaved threads in a multi-thread mode. This is shown in relation to FIG. 4, where a pipelined processor can be adapted to perform each of the IF, ID and EX stages as a single thread (ST) 402 or as an intra-core 2-phase time interleaving mode (or dual thread (DT) 404 mode). When the dual thread mode is enabled, each of the IF, ID and EX stages are split into two, thereby enabling its dual-thread operation and reducing leakage energy/cycle. As shown in FIG. 4, in the dual thread mode 404, the IF stage is split into IF0 and IF1, the ID stage is split into ID0 and ID1, and the EX stage is split into EX0 and EX1 threads. The pipelined processor can be adapted to be selectable between the single thread mode or the dual thread mode in the present embodiment. In other embodiments, a multi-thread mode having, for example, three or more threads can be used.

Energy efficiency at near-threshold (e.g. minimum energy) can be improved by sharing outputs from the IF stage and the ID stage across the two threads by each of the pipelined processors, as allowed in regular or Single Instruction, Multiple Data (SIMD) workloads where the two threads execute the same program. Therefore, in this case, the pipelined processor is adapted to share an IF pipeline output of the IF stage and/or an ID pipeline output of the ID stage between the two or more interleaved threads. This is termed as the “SIMD” mode.

In the present embodiment where multiple pipelined processors are used, greater level of sharing can be employed across all of the pipelined processors simultaneously.

For example, an IMEM output from the instruction memory (IMEM) module 306 of the primary pipelined processor 310 can be shared across to the other secondary pipelined processors 317, 319, 321 for use in the multi-stage pipelines of each of these secondary pipelined processors 317, 319, 321 as allowed when all the pipelined processors 310, 317, 319, 321 execute the same programme. In this case, the very same instructions are shared and hence only the primary core is required to access the IMEM module 306 which needs to remain active, while the other IMEM modules for each of the secondary cores 316, 318, 320 are not used. It should, however, be noted that the DMEM modules for each of the primary and secondary cores 302, 316, 318, 320 remain active as all cores will work on different data even if they are executing the same instructions. This is shown as “IMEM” sharing in relation to FIG. 3, and is termed as the “SIMD-MS” (Single Instruction, Multiple Data—Memory Sharing) mode.

Further instruction sharing can also be achieved inter-core between the primary pipelined processor 304 and the secondary pipelined processors 317, 319, 321. This is shown in relation to FIG. 4 where the IF pipeline output of the IF stage 406 and the ID pipeline output of the ID stage 408 of the primary pipelined processor 310 can be shared across all to the respective IF and ID stages of the secondary pipelined processors 317, 319, 321. Each of the pipelined processors 310, 317, 319, 321 are then configured to execute their EX stage 410 independently. In this case, energy efficiency of the reconfigurable processor 302 is improved by sharing the IF pipeline output and the ID pipeline output of the primary pipelined processor 310 to the secondary pipelined processors 317, 319, 321. It should be appreciated that in other embodiments, the IF pipeline output or the ID pipeline output is shared between the pipelined processors 310, 317, 319, 321 instead of sharing both the IF pipeline output and the ID pipeline output as illustrated in relation to FIG. 4.

In the present embodiment, the inter-core instruction sharing of the IF pipeline output and the ID pipeline output can be combined with the sharing of the IMEM output of the IMEM module 306 for the primary pipelined processor 310 and the secondary pipelined processors 317, 319, 321 when these pipelined processors 310, 317, 319, 321 execute a same program. This is known as the SIMD+ mode and further reduction in energy can be achieved. The SIMD+ mode offers the highest amortization of the energy cost of control flow (IF+ID, and IMEM) among all the pipelined processors and threads in the present embodiment. As a result, the energy required in the SIMD+ mode approaches that used by the EX stages of the pipelined processors, which is the energy that would be necessary for the intended computation, similar to an accelerator based on a processing element array.

Inter-core/thread communication energy in the SIMD+ mode can be further reduced by inserting memory-mapped systolic registers 322, allowing regular/systolic output transfer at no memory access. This is shown in relation to FIG. 3. Moreover, the pipelined processors 310, 317, 319, 321 can be configured or adapted to incorporate configurable bit precision from 4 bits to 32 bits in the EX unit for more efficient MAC operations e.g. when used in typical machine learning workloads. When the SIMD+ mode is employed with 4-bit operations at the EX units associated with the pipelined processors 310, 317, 319, 321, it is termed as the “SIMD+4b” mode. The bit precision can be set statically via special registers for the secondary pipelined processors 317, 319, 321. In the present embodiment, the primary pipelined processor 310 does not have precision configurability to preserve control flow integrity. In an embodiment, the reconfigurable processor 302 comprises a watchdog unit adapted to monitor the pipelined processor 310 for malfunctions or deadlock conditions.

A summary of the various operating modes of the reconfigurable processor 302 of the present embodiment is provided in Table 1 below.

TABLE 1
Operating modes of the reconfigurable processor.

| | | | | ops/cycle | #active IF, | |
|---|---|---|---|---|---|---|
| mode | Description | #data/inst. | ops./cycle/core | (cluster) | ID stages | throughput |
| ST | single thread | 1 | 1 | 4 | 4 | x |
| | (baseline) | | | | | |
| DT | dual-thread | 1 | 1 | 4 | 4 | 2x |
| | (time- | | | | | |
| | interleaved) | | | | | |
| SIMD | intra-core | 2 | 1 | 4 | 4* | 2x |
| | IF/ID sharing | | | | | |
| SIMD-MS | inter-core | 8 | 1 | 4 | 4* | 2x |
| | IMEM sharing | | | | | |
| SIMD+ | inter-core | 8 | 1 | 4 | 1* | 2x |
| | IF/ID and | | | | | |
| | IMEM sharing | | | | | |
| SIMD + 4b | same as | 64 | 1-primary, | 32 | 1* | 16x |
| | SIMD+ with | | 8-secondary | | | |
| | 4-bit ops | | | | | |

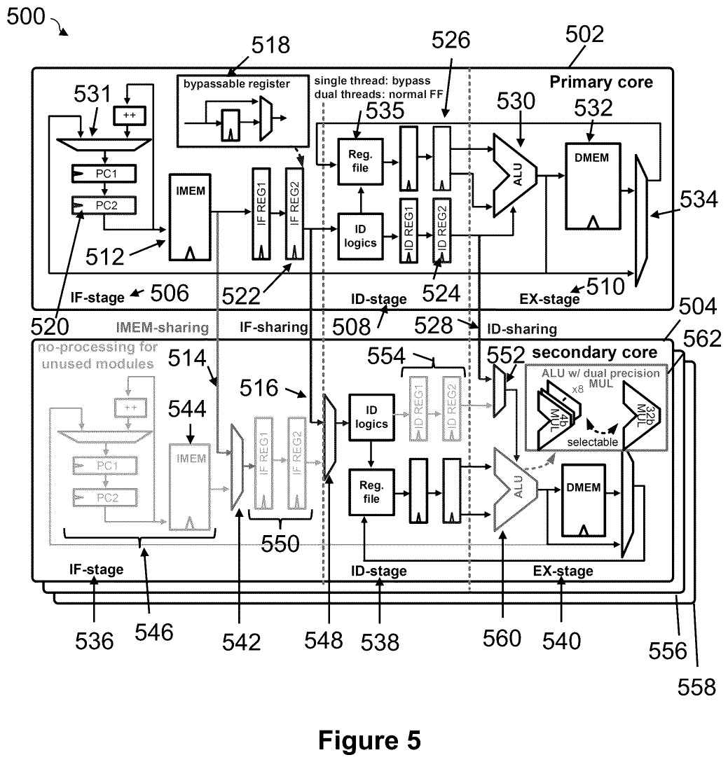

FIGS. 5 to 7 provide further illustrations of the various operating modes as described above.

FIG. 5 shows a block diagram 500 of a multi-stage pipeline of a primary pipelined processor 502 and a further multi-stage pipeline of a secondary pipelined processor 504 in accordance with an embodiment. In the present embodiment, a 22 nm FD-SOI technology platform was used with a low-energy cell library including four (4) ARM® Cortex®-M0 micro-controllers as shown in relation to FIG. 3 above. Each of the pipelined processors 310, 317, 319, 321 includes a 8-KB instruction memory (IMEM) module and a 8-KB data memory (DMEM) module.

As shown in the block diagram 500 of FIG. 5, the primary pipelined processor 502 is configured to execute an instruction set in a multi-stage pipeline including an instruction fetch (IF) stage 506, an instruction decode (ID) stage 508 and an execute (EX) stage 510. The instruction fetch (IF) stage 506, the instruction code (ID) stage 508 and the execute (EX) stage 510 each involves various components associated with the primary pipelined processor 502 as shown in the block diagram 500.

As shown in relation to FIG. 5, at the IF stage 506, instructions are received from the program counter 1 (PC1) and/or program counter 2 (PC2) 520 at the IMEM module 512. PC1 and PC2 in FIG. 5 are used to represent the program counter for the time-interleaved phases/threads #1 and #2, respectively. In an embodiment having a baseline single-core processor without the proposed selectable time interleaving and involving a single thread, there would be a single program counter. Instruction set from the IMEM module 512 is then passed to the IF REG 1 and/or IF REG2 522 (depending on whether it is a single thread or a dual thread). As shown in FIG. 5, an IMEM output from the IMEM module 512 can be shared between the primary pipelined processor 502 and the secondary pipelined processor 504 in an IMEM sharing process 514. Further, in addition to or alternatively, an output from the IF REG1 or the IF REG2 522 (or an IF pipeline output from the IF stage) can be shared between the primary pipelined processor 502 and the secondary pipelined processors 504 as shown in the IF-sharing process 516.

Also shown in the block diagram 500 is a bypass register 518. The bypass register 518 is adapted to allow the pipelined processor to switch between performing a pipeline stage (e.g. an IF stage) in a single-thread mode and a dual-thread mode. In the present embodiment as shown in relation to FIG. 5, bypass registers can be employed for PC2 520, IF REG2 522, ID REG2 524 and REG2 526 associated with Reg. file 535 of the ID-stage of the primary pipelined processor 502.

Further, the ID pipeline output (i.e. from the ID REG2 524 as shown in this case) from the ID-stage 508 of the primary pipelined processor 502 can be shared with at least one of the secondary pipelined processor 504 in an ID-sharing process 528, as shown in the block diagram 500.

In an embodiment, the IMEM output, the IF pipeline output and/or the ID pipeline output from the primary pipelined processor 502 can be shared with more than one or all of the secondary pipelined processors.

Following the three-stage pipeline stage flow as shown in relation to FIG. 5 of the present embodiment, the ID pipeline output from the ID REG2 524 is provided to an arithmetic logic unit (ALU) 530. An output of the ALU 530 is provided to a data memory (DMEM) module 532, which in turn provides an input relating to the data retrieved from the memory (DMEM) module 532 at the address provided by the ALU 530 to an EX output multiplexer 534 which can be used for providing an EX pipeline output of the EX-stage 510. As shown in FIG. 5, the other input to the EX output multiplexer 534 relates to an input provided directly by the ALU 530 based on the ALU computation. The output of the EX output multiplexer 534 is provided to write back on the register file (i.e. Reg. file 535), which includes either (i) the output of the ALU 530 for register-to-register operations, or (ii) data read from the data memory (DMEM) module 532 related to the address provided by the ALU 530 for memory read operations. Referring back to the ALU 530, an output of the ALU 530 can also be provided to a multiplexer 531 connected to the PC1. In summary, the output of the ALU 530 can be used either to write onto the register file 535 via the EX output multiplexer 534, or to set the next address of the program counter PC1 via the multiplexer 531 (e.g., if a jump/branch instruction is being executed).

As shown in relation to FIG. 5, similar components are made available to the secondary pipelined processor 504, as discussed for the primary pipelined processor 502, for use in a three-stage pipeline stage i.e. an IF-stage 536, an ID-stage 538 and an EX-stage 540. Descriptions of these components or stages are not provided in detail again for succinctness. However, using the secondary pipelined processor 504 as shown in relation to FIG. 5, the IMEM sharing process 514, the IF-sharing process 516 and the ID-sharing process 518 and their impacts on the components of the secondary pipelined processor 504 are discussed below.

For example, in the IMEM sharing process 514, an IMEM output of the IMEM module 512 of the primary pipelined processor 502 is shared with the secondary pipelined processor 504, and in this embodiment, as an input to a IMEM multiplexer 542 positioned after an IMEM module 544 of the secondary pipelined processor 504. The IMEM multiplexer 542 is adapted to select an input from either an IMEM output from the IMEM module 512 of the primary pipelined processor 502 or an IMEM output from the IMEM module 544 of the secondary pipelined processor 504. In the IMEM sharing process 514, therefore, an IMEM output from the IMEM module 512 of the primary pipelined processor 502 can be selected as an input to the subsequent process, and components 546 of the secondary pipelined processor 504 are not used. In this case, no processes will be performed by the components 546 and therefore the energy used by the secondary pipelined processor 504 is reduced.

The above concept for energy reduction can also be applied to the IF-sharing process 516 and the ID-sharing process 528. As illustrated in relation to FIG. 5, in the IF-sharing process 516, an IF pipeline output from the IF REG2 522 can be provided as an input to an IF multiplexer 548 of the secondary pipelined processor 504 which is adapted to select an input from either the IF pipeline output from the IF REG2 522 of the primary pipelined processor 502 or an IF pipeline output from the IF REG2 of the secondary pipelined processor 504. In the IF-sharing process 516, therefore, the IF pipeline output from the IF REG2 522 of the primary pipelined processor 502 is selected as an input to the subsequent ID-stage of the secondary pipelined processor 504, and components 550 (i.e. IF REG1 and IF REG2) of the secondary pipelined processor 504 are not used. In a similar vein, in the ID-sharing process 528, an ID pipeline output from the ID REG2 524 can be provided as an input to an ID multiplexer 552 of the secondary pipelined processor 504 which is adapted to select an input from either the ID pipeline output from the ID REG2 524 of the primary pipelined processor 502 or an ID pipeline output from the ID REG2 of the secondary pipelined processor 504. In the ID-sharing process 528, therefore, the ID pipeline output from the ID REG2 524 of the primary pipelined processor 502 is selected as an input to the subsequent ID-stage of the secondary pipelined processor 504, and components 554 (i.e. ID REG1 and ID REG2) of the secondary pipelined processor 504 are not used. Therefore, in the IF-sharing process 516 or the ID-sharing process 528, the secondary pipelined processor 504 made use of (or reuse) the respective IF pipeline output or the ID pipeline output of the primary pipelined processor 502, thereby reducing the energy used by the secondary pipelined processor 504 to the actual computation (i.e. the EX stage) and substantially reducing the energy used by the secondary pipelined processor 504 down to the energy used by an accelerator (without control flow).

Therefore, as illustrated in relation to FIG. 5, in the present embodiment where the IMEM-sharing process 514, the IF-sharing process 516 and the ID-sharing process 528 are utilised between the primary pipelined processor 502 and the secondary pipelined processor 504, the components 546, 550 and 554 of the secondary pipelined processor 504 are not used or processed, thereby providing a reduction to the energy used by the secondary pipelined processor 504 and achieving a minimum energy used (i.e. close to EX stage energy) in the secondary pipelined processor 504. It should be appreciated that these sharing processes 514, 516, 528 can be extrapolated and used in a multi-core processor system. For example, in the present embodiment where there are four pipelined processors (i.e. one primary pipelined processor 502 and three secondary pipelined processors 504, 556, 558), the relevant outputs from the primary pipelined processor 502 can be shared with all of the other three secondary pipelined processors 504, 556, 558. It should also be appreciated that the various sharing process 514, 516, 528 can be used in any combination. For example, the IMEM-sharing process 514 can be used alone or in conjunction with the IF-sharing process 516 and/or the ID sharing process 528. The combination of the sharing processes 514, 516, 528 is also selectable. In the present embodiment, selection of the sharing processes 514, 516, 528 is enabled by the multiplexers 542, 548, 552 of the secondary pipelined processor 504.

Further, in the present embodiment, an arithmetic logic unit (ALU) 560 of the secondary pipelined processor 504 can be adapted to change the bit precision of an EX pipeline output of the secondary pipelined processor 504. This is illustrated in an inset 562 where the ALU 560 is configured to have a dual precision multiplication logic (MUL) which is adapted to switch between a 4-bit precision and a 32-bit precision, and vice versa. In the present embodiment, the primary pipelined processor 502 does not have precision configurability to preserve control flow integrity. In other words, the ALU 530 of the primary pipelined processor 502 in the present embodiment is not adapted to switch between the 4-bit precision and the 32-bit precision for the EX pipeline output of the primary pipelined processor 502.

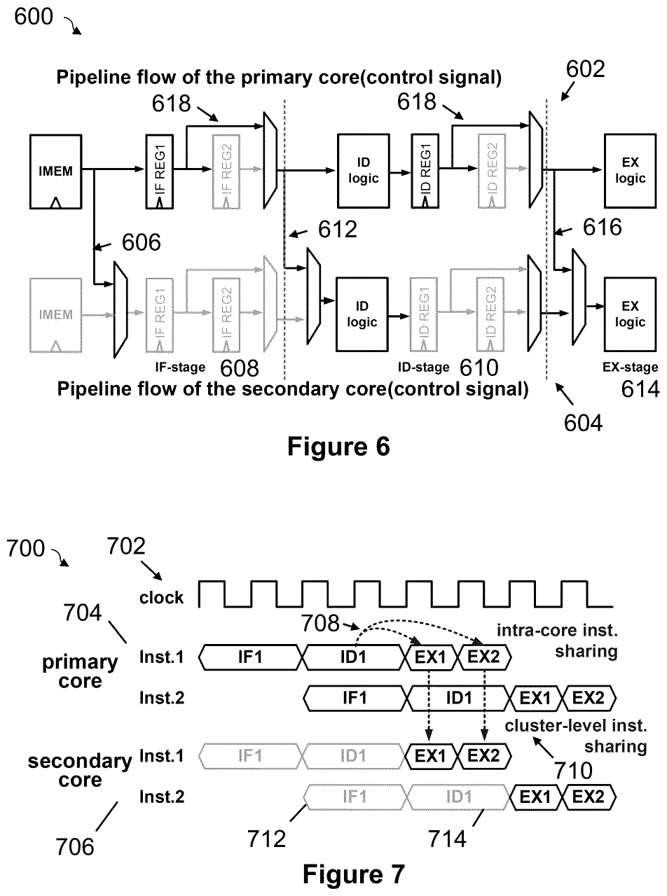

FIG. 6 shows a block diagram illustrating a pipeline flow 600 of the primary pipelined processor 502 and a further pipeline flow of the secondary pipelined processor 504 of FIG. 5, in accordance with an embodiment.

The pipeline stage flow for the primary pipelined processor 502 is shown in a row 602 while the pipeline stage flow for the second pipelined processor 504 is shown in a row 604. As discussed in relation to FIG. 5, one or more sharing processes can be applied between the primary pipelined processor 502 and the secondary pipelined processor 504, and this is also shown in the pipeline flow 600 of FIG. 6. For example, in the present embodiment, an IMEM output from the IMEM module of the primary pipelined processor 502 is shared with the secondary pipelined processor 504 in a IMEM-sharing process 606, an IF pipeline output of an IF stage 608 of the primary pipelined processor 502 is shared as an ID input to an ID stage 610 of the secondary pipelined processor 504 in an IF-sharing process 612, and an ID pipeline output of the ID stage 610 of the primary pipelined processor 502 is shared as an ID input to an EX stage 614 of the secondary pipelined processor 504 in an ID-sharing process 616. Also shown in the pipeline flow 600 of FIG. 6 is that a bypass register 618 is used in each of the IF stage 608 and the ID stage 610 which allows the primary pipelined processor 502 to switch between performing the IF and the ID stages in a single-thread mode or in a dual-thread mode in the present embodiment.

FIG. 7 shows a schematic of a timing diagram 700 to illustrate pipeline stage execution in the primary pipelined processor 502 and the secondary pipelined processor 504 of FIG. 5, in accordance with an embodiment. A clock signal sequence 702 of the reconfigurable processor is shown as 702.

The pipeline stage execution of the primary pipelined processor 502 is shown in a row 704 and the pipeline stage execution of the secondary pipelined processor 504 is shown in a row 706. As shown in the timing diagram 700, intra-core sharing 708 (i.e. the SIMD mode) can be performed, for example, within the primary pipelined processor 504 where, in this case, an ID pipeline output from the ID stage is shared between the dual threads and provided as an input to the EX1 and EX2 stages of the dual-thread primary pipelined processor 704. Also shown in the timing diagram 700 is the inter-core sharing process 710 (i.e. the SIMD+ mode) where the IMEM output, the IF pipeline output and the ID pipeline output of the primary pipelined processor 502 are shared with the secondary pipelined processor 504. As described in relation to FIG. 5, components relating to the IF stage 712 and the ID stage 714 of the secondary pipelined processor 504 are therefore not used (shown in grey colour) and thereby saving energy for the secondary pipelined processor 504.

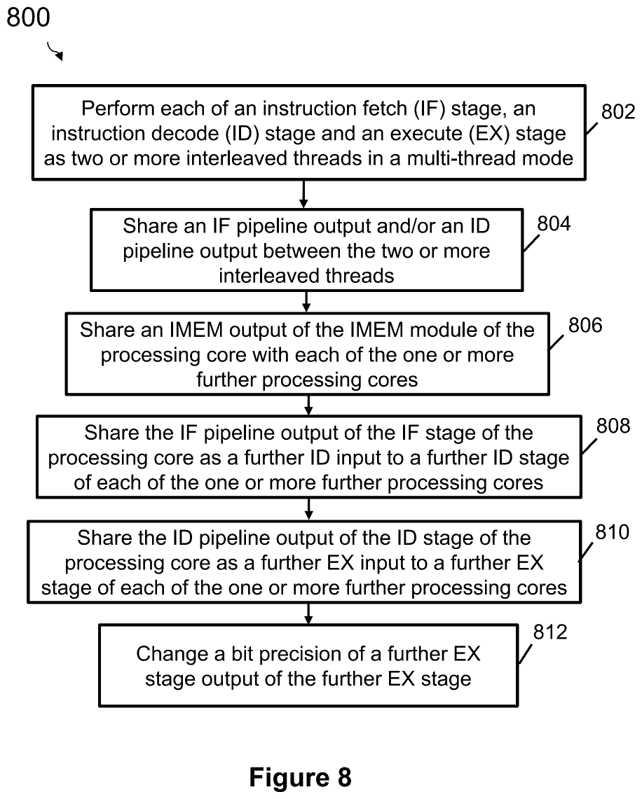

FIG. 8 is a flowchart of a method 800 for improving an efficiency of the reconfigurable processor 302 of FIG. 3 in accordance with an embodiment.

In a step 802, a pipelined processor is adapted to perform each of the IF, ID and EX stages as two or more interleaved threads in a multi-thread mode. Having the pipelined processor being adapted to execute pipeline stages in a multi-thread mode allows for better multi-tasking and an improved performance for certain workloads as the pipelined processor can be configured to manage multiple tasks concurrently, thereby enhancing resource utilization and responsiveness.

In a step 804, the pipelined processor is adapted to share an IF pipeline output of the IF stage and/or an ID pipeline output of the ID stage between the two or more interleaved threads. In an embodiment, this can be implemented by the use of a bypass register in each of the IF stage and/or the ID stage as discussed in relation to FIG. 5. By sharing the outputs of the IF stage and/or the ID stage across the two or more interleaved threads within each pipelined processor, an energy efficiency at near-threshold (e.g. minimum energy) is improved.

In a step 806, where the reconfigurable processor 302 comprises one or more further (or secondary) pipelined processors and further memory modules for each of the one or more further pipelined processors, each of the one or more further pipelined processors are configured to execute the instruction set in a further multi-stage pipeline including a further IF stage, a further ID stage and a further EX stage, and an instruction memory (IMEM) module associated with the pipelined processor (e.g. a primary pipelined processor 502) is adapted to share an IMEM output of the pipelined processor with each of the one or more further pipelined processors.

In a step 808, the pipelined processor is adapted to share the IF pipeline output of the IF stage of the pipelined processor as a further ID input to the further ID stage of each of the one or more further pipelined processors. This is, for example, illustrated as the IF-sharing process 516 of FIG. 5.

In a step 810, the pipelined processor is adapted to share the ID pipeline output of the ID stage of the pipelined processor as a further EX input to the further EX stage of each of the one or more further pipelined processors. This is, for example, illustrated as the ID-sharing process 528 of FIG. 5.

In a step 812, a bit precision of the further EX stage output of the further EX stage of the one or more further pipelined processors is changed, for example, from 4 bits to 32 bits and vice versa. In the present embodiment, this can be facilitated by an arithmetic logic unit (ALU) configured to have a dual precision MUL which is adapted to switch between a 4-bit precision and a 32-bit precision, and vice versa.

It should be appreciated that one or more of the steps 802, 804, 806, 808, 810, 812 can be optional and they may not occur in sequence as suggested by the flowchart of FIG. 8. For example, pipelined processors of a reconfigurable processor may not be performed in a multi-thread mode (and so the steps 802 and 804 may not be performed) but inter-core sharing processes such as the steps 806, 808 and 810 may be used. In other embodiments, the steps 802, 804 for intra-core sharing in multi-thread pipelined processors are used, together with either the step 806 for inter-core IMEM sharing or the steps 808 and/or 810 for inter-core IF and/or ID sharing. Other feasible combinations of these sharing processes may also be applicable.

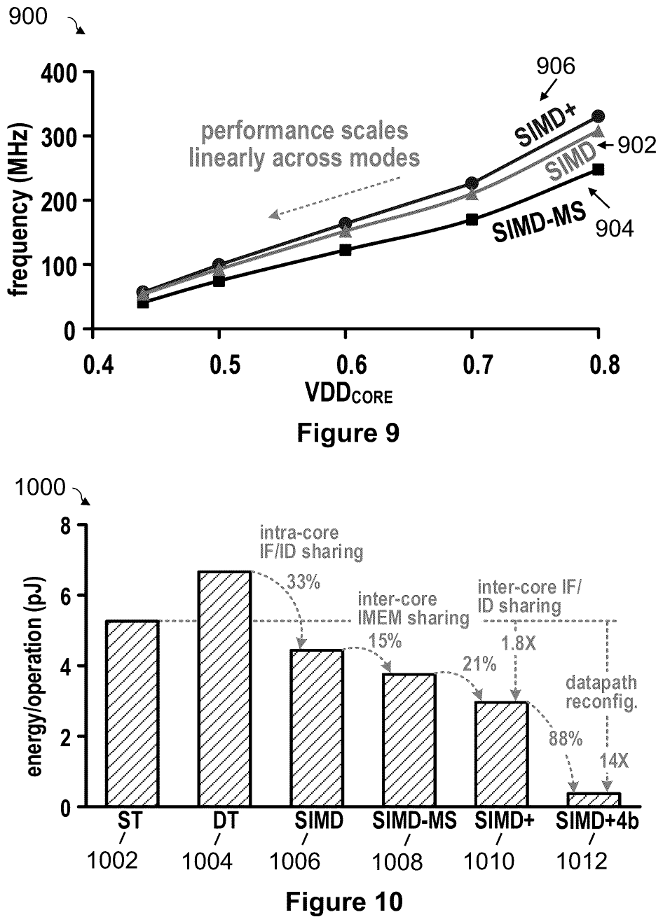

FIG. 9 shows a plot 900 of frequency versus a supply voltage VDD of the pipelined processors for various operating modes in accordance with an embodiment. Triangular data points for the SIMD mode 902, square data points for the SIMD-MS mode 904 and circle data points for the SIMD+ mode 906 are shown.

As shown in the plot 900, the clock frequency in the SIMD+ mode reaches about 330 MHz, resulting in a peak performance of 18.8 Giga operations per second (GOPS) at 4 bit (or 2.6 GOPS at 32 bit) when executing MAC operations. This is a 14.5× (or 2× improvement for a 32-bit EX pipeline output) improvement over a conventional 32-bit operation with 4 baseline cores. Also shown in the plot 900 is that the clock frequency of the SIMD mode 902, the SIMD-MS mode 904 and the SIMD+ mode 906 scale almost linearly with the applied voltage to the pipelined processor VDD_{core}.

FIG. 10 shows a plot 1000 of energy per operation for various operating modes in accordance with an embodiment. The bar charts for the single-thread (ST) mode 1002, the dual-thread (DT) mode 1004, the SIMD mode 1006, the SIMD-MS mode 1008, the SIMD+ mode 1010 and the SIMD+4b mode 1012 are shown.

From the plot 1000 of FIG. 10, it is shown that there is an energy reduction of about 33% for the SIMD mode 1006 over the DT mode 1004, there is an energy reduction of about 15% for the SIMD-MS mode 1008 over the SIMD mode 1006, there is an energy reduction of about 21% for the SIMD+ mode 1010 over the SIMD-MS mode 1008, and there is an energy reduction of about 88% for the SIMD+4b mode 1012 over the SIMD+ mode 1010. Comparing with the single-thread (ST) mode 1002, the SIMD+ mode 1010 shows a 1.8× energy reduction and the SIMD+4b mode 1012 shows a 14× energy reduction under 4-bit precision over the ST mode 1002. Comparing with the dual-thread mode 1004, the SIMD+ mode 1010 also shows a 2.3× energy reduction.

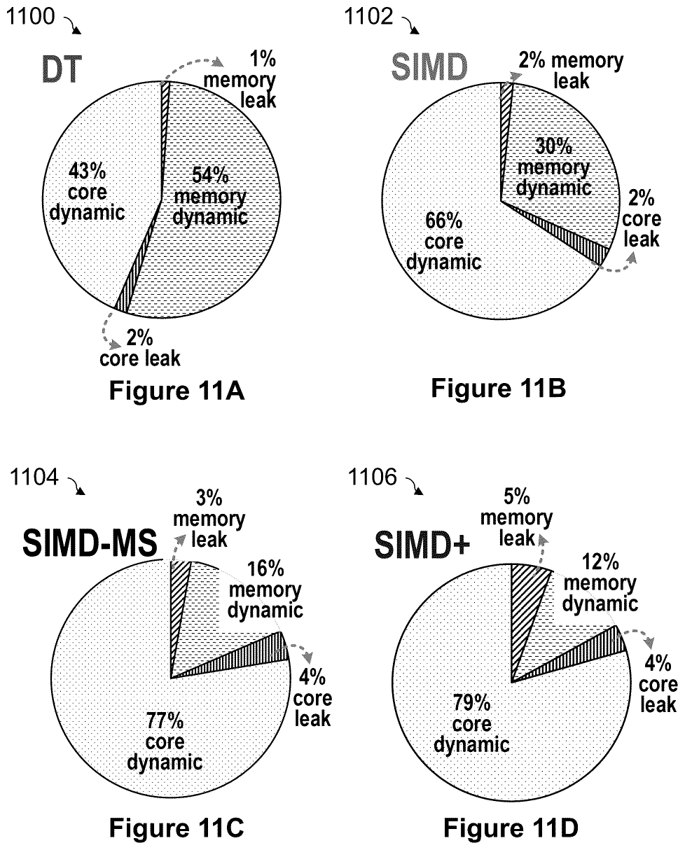

FIGS. 11A, 11B, 11C and 11D show pie charts of a measured power breakdown for various operating modes in accordance with an embodiment.

FIG. 11A shows a pie chart 1100 of a measured power breakdown for a dual thread (DT) mode, FIG. 11B shows a pie chart 1102 of a measured power breakdown for an intra-core IF/ID sharing (SIMD) mode, FIG. 11C shows a pie chart 1104 of a measured power breakdown for an inter-core IMEM sharing (SIMD-MS) mode, and FIG. 11D shows a pie chart 1106 of a measured power breakdown for an inter-core IF/ID and IMEM sharing (SIMD+) mode.

Moving from the DT mode to the SIMD mode as shown in relation to the pie charts 1100 and 1102, the intra-core sharing between threads of a pipelined processor reduces energy utilised by the IMEM module, thereby increasing the total energy efficiency. Comparing the SIMD mode to the SIMD-MS mode as shown in relation to the pie charts 1102 and 1104, the IMEM sharing process (i.e. intra-cluster or inter-cores) further reduces the memory dynamic energy (this can be significant as the memory is running at a higher supply). Finally, comparing the SIMD-MS mode to the SIMD+ mode as shown in relation to the pie charts 1104 and 1106, the IF sharing process and the ID sharing process (i.e. intra-cluster or inter-cores) reduce the absolute core energy and improves an overall energy efficiency of the reconfigurable processor. Overall, the cumulative benefit of the sharing processes used in the SIMD+ mode make the core energy (mostly energy expended in the EX pipeline stage) dominant, thanks to the amortization of energy associated with the IF and/or ID pipeline stage and the energy of the IMEM modules across all threads in the pipelined processors.

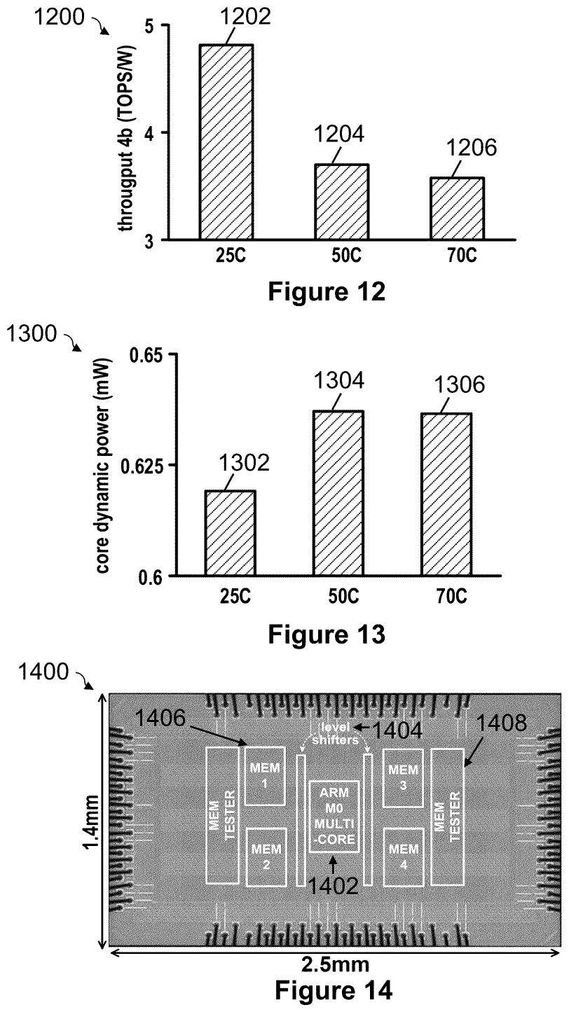

FIG. 12 shows a bar chart 1200 of measured throughput at 4 bits versus operating temperatures in accordance with an embodiment. The throughput at 4 bits is provided in the units of Tera operations per second per Watts (TOPS/W). The bar graphs 1202, 1204, 1206 are provided for operating temperatures of 25° C., 50° C. and 70° C., respectively. The bar chart 1200 was measured with a supply voltage to the pipelined processors, VDD_{core}, at 0.44V and at near-threshold. As shown in the bar graphs 1202, 1204, 1206, an energy efficiency of the reconfigurable processor reduces at higher temperatures. This is likely due to an increased leakage in the pipelined processors for this FD-SOI platform at higher temperatures.

FIG. 13 shows a bar chart 1300 of measured core dynamic power versus operating temperatures in accordance with an embodiment. The bar graphs 1302, 1304, 1306 are provided for operating temperatures of 25° C., 50° C. and 70° C., respectively. The bar chart 1300 was also measured with a supply voltage to the pipelined processors, VDD_{core}, at 0.44V and at near-threshold in the SIMD+ mode. As shown in the bar graphs 1302, 1304, 1306, the higher core dynamic power increases with temperatures. This is again likely due to an increased leakage in the pipelined processors for this FD-SOI platform with increasing temperatures.

From the bar charts 1200, 1300 as shown in relation to FIGS. 12 and 13, in the present embodiment, the worst performance of the reconfigurable processor occurs at the highest operating temperature of 70° C. This condition also provides for the worst energy efficiency and the worst robustness (e.g. Vₘᵢₙ).

FIG. 14 shows a micrograph 1400 of the reconfigurable processor used in experiments for obtaining the results shown in relation to FIGS. 9 to 13. As shown in the micrograph 1400, in the present embodiment, a reconfigurable processor comprising 4 ARM® Cortex® M0 pipelined processors 1402 was used. Level shifters 1404 and memory modules (MEM 1, MEM 2, MEM 3 and MEM 4) 1406 flanking the 4 ARM® Cortex® M0 pipelined processors 1402 are also shown. Finally, MEM testers 1408 are provided at each outermost sides of the 4 ARM® Cortex® M0 pipelined processors 1402 as shown in the micrograph 1400.

The parameters of the computing architecture used in the present embodiment are listed in Table 2 below.

TABLE 2
Parameters of the reconfigurable processor
of the present embodiment.

| | |
|---|---|
| technology | 22 nm-FD-SOI |
| chip size | 2.5 mm × 1.4 mm |
| | Core: 4 ARM ® Cortex ® M0 (0.3 mm²) |
| | Memory 64 KB (0.11 mm²) |
| memory | 64 KB |
| | 8 KB - Program Mem/M0-core |
| | 8 KB - Data Mem/M0-core |
| architecture | ARM Cortex M0 |
| #physical cores | 4 |
| #threads | 4-64 |
| supply | 0.44 V-0.8 V |
| body bias | P: −2 to 0 V, N: 0 to 2 V |
| frequency | 56 MHz-330 MHz |
| power (total) | 0.67-10.2 mW |

TABLE 3
Comparison with state of the art.

| | This work | [4] | [5] | [6] | [7] | [1] | [2] | [3] |
|---|---|---|---|---|---|---|---|---|
| technology | 22 nm- | 40 nm | 22 nm- | 55 nm | 28 nm- | 28 nm | 65 nm | 65 nm |
| | FD-SOI | | FD-SOI | | FD-SOI | CMOS | CMOS | CMOS |
| architecture | Cortex-M0 | Cortex-M0 | Cortex-M0+ | Cortex-M0 | Cortex-M0 | Cortex-M4F | RISC-V | RISC-V |
| | | | (2pipestg) | | | | | |
| area (mm²) | 0.41 (4 | 0.15 | 0.0553^{C} | NA | 0.439* | 11.3 | 4.32 | 6.96 |
| | cores) | | | | | | | |
| supply (V) | 0.44-0.8 | 0.4-1.1 | 0.4-0.8 | 0.48- | 0.4- | 0.55-1 | 0.5-1.0 | 0.8-1.2 |
| | | | | 0.75, 1.2 | 0.8, 1.8 | | | |
| memory (KB) | 64 | 16 | 12 | 8 | 64 | 1.27 MB | 150 | 208 |
| frequency range | 56 MHz- | 200 KHz- | 13.7 MHz- | 100 KHz- | 10 MHz- | 12 MHz- | 400 MHz | 60- |
| | 330 MHz | 250 MHz | 651 MHz | 6 MHz | 80 MHz | 510 MHz | | 205 MHz |
| min. | 1.48 pJ (32b) | 3.52 pJ | 1.13 pJ | 6.4 pJ | 3.3 pJ | 16.7 pJ | — | 14.8 pJ |
| energy/cycle/core | 0.207 pJ(4b) | (2.8 MHz) | (20 MHz) | (500 KHz) | (40 MHz) | (31 MHz) | | |
| (frequency) | (56 MHz) | | w/RBB | | w/FBB | | | |
| accelerators | No | No | No | No | FFT | No | CPU/DNN | No |
| no. of physical | 4 (up | 1 (up | 1 (1) | 1 (1) | 1 (1) | 32 (32) | 10 (CPU) | 16 (16) |
| cores (threads) | to 8) | to 2) | | | | | 100 (DNN) | |
| peak energy | 0.61 (32b) | 0.274 | 0.885 | 0.156 | 0.303^{A} | 0.0364 | 1.8 (8b) | 0.303 (8b) |
| efficiency | 4.84 (4b) | @ 0.51 V | @0.42 V | @0.55 V | @ 0.4 V | | @0.5 V | 0.57 (4b) |
| (TOPS/W) | @ 0.44 V | | | | | | | @ 0.8 V |
| peak throughput | 2.6 (32b) | 0.5 | 0.651 | 0.006 | 0.08^{A} | 11.9 | 77 (8b) | 15 (8b) |
| (GOPS) | 18.8 (4b) | | | | | | | 30 (4b) |
| peak | 0.29 (32b) | 0.5 | 0.651 | 0.006 | 0.08^{A} | 0.372 | 0.77 (8b) | 0.94 (8b) |
| throughput/core | 2.35 (4b) | | | | | | | 1.875 (4b) |
| (GOPS/core) | | | | | | | | |
| peak area | 6.4 (32b) | 3.33 | 11.8 | — | 0.182 | 1.05^{B} | 17.8 (8b) | 2.16 (8b) |
| efficiency | 45.9 (4b) | | | | | | | 4.31 (4b) |
| w/MEM | | | | | | | | |
| (GOPS/mm²) | | | | | | | | |
| norm. peak area | 13.2 (32b) | 2.08 | 24.4 | — | 0.232 | 1.34^{B} | 4.21 (8b) | 0.511 (8b) |
| efficiency | 94.8 (4b) | | | | | | | 1.02 (4b) |
| w/MEM | | | | | | | | |
| (GOPS/mm²/F²) | | | | | | | | |

Finally, Table 3 provides a comparison of the present example of using 4 ARM® Cortex® M0 pipelined processors 1402 on a 22 nm FD-SOI technology platform with existing prior art. From Table 4, it is shown that the present embodiment improves the minimum energy by 8.4× over [3] at a same 4 bit, improves the minimum energy by 1.3× over [2] at 8 bit (having 22.5× worse normalized area efficiency), and improves the minimum energy by 2× to 3.9× over [1], [4], [6], [7] at 32 bit based on using the same ARM® Cortex®-M0 core ([5] has a simpler 2-pipeline stage microarchitecture). Further, the present example improves technology-normalized area efficiency over all these other ARM® Cortex®-M0 core by 3.1× to 57× at 32 bit, and by an even larger factor at 4 bits. Overall, the energy and area efficiency improvements in the present example are achieved while preserving software programmability and software stack. [1] to [7] in Table 3 refers to references provided at the References section at the end of this description.

### CONCLUSIONS

The reconfigurable processor and the method of improving an efficiency of the reconfigurable processor of the present disclosure provide various sharing processes/schemes for improving an energy efficiency and an area efficiency of the reconfigurable processor.

In the exemplary embodiment, an ultra-low power ARM® Cortex®-M0 processor 4-core cluster is used as a reconfigurable processor which is adapted to operate concurrently for up to 32 data bit, while reducing energy via fetch (IF) and/or decode (ID) pipeline stage sharing and/or IMEM sharing across the pipelined processors under a common program execution (e.g., MACs). The multi-core architecture of the present embodiment as shown can be adapted to support up to 8 threads (e.g. dual-thread in each pipelined processor) by suitable arrangement of the 4 pipelined processors, and to support inter-core systolic data flow via memory-mapped systolic registers. When combined with a low-energy standard cell library, the architectural reconfigurability provided by the present example achieves a 1.8× to 14× energy reduction over a single-core baseline, and more than 3.1× improved area efficiency over the referenced prior art. Further, as demonstrated using a 22 nm FD-SOI platform in the exemplary embodiment, state-of-the-art energy reductions down to 0.3 pJ/instruction were obtained with up to 13.7× area efficiency improvement compared with the single-core baseline. The proposed multi-core processor architecture is able to achieve competitive energy and area efficiency while preserving software programmability/flexibility, and allowing full reuse of the existing software stack of a single-core implementation.

Although the exemplary embodiment was provided using a ARM® Cortex®-M0 processor 4-core cluster as the reconfigurable processor, it should be appreciated that other types of processors or other number of multi-core cluster can be used. It should also be noted that a size of the cluster or multi-core cluster (e.g. a number of pipelined processors per cluster) can varied, and is not restricted to four pipelined processors as in the exemplary embodiment. Moreover, it should be appreciated that the present disclosure can work with conventional cell library.

Further, although the FD-SOI technology is used in the present embodiment, it should be appreciated that other technologies such as bulk CMOS and FinFET can be used and applied to the present disclosure.

Alternative embodiments may include: (i) a reconfigurable processor comprising more than one single-thread pipelined processor and utilising one or more of the IMEM sharing process, the IF sharing process and the ID sharing process as described above; (ii) a reconfigurable processor comprising one or more further pipelined processors, where the one or more further pipelined processors are adapted to change a bit precision of its further EX stage output from a precision of 4 bit to other suitable bit precision, such as 8 bits, 16 bits or 64 bits; (iii) a reconfigurable processor being adapted to receive mode inputs for selecting between the various operating modes (e.g. ST mode, DT mode, SIMD mode, SIMD-MS mode, SIMD+ mode and SIMD+4b modes) for operating the reconfigurable processor; (iv) implementing the reconfigurable processor on other suitable technology platforms other than the 22 nm FD-SOI technology platform as used in the exemplary embodiment; and (v) implementing the sharing processes across a processor with a higher number of pipeline stages.

Although only certain embodiments of the present invention have been described in detail, many variations are possible in accordance with the appended claims. For example, features described in relation to one embodiment may be incorporated into one or more other embodiments and vice versa.

### REFERENCES

[1] S. Kim et al., “Versa: A 36-Core Systolic Multiprocessor With Dynamically Reconfigurable Interconnect and Memory,” in IEEE Journal of Solid-State Circuits, vol. 57, no. 4, pp. 986-998, April 2022, doi: 10.1109/JSSC.2022.3140241.
[2] Y. Ju and J. Gu, “A Systolic Neural CPU Processor Combining Deep Learning and General-Purpose Computing With Enhanced Data Locality and End-to-End Performance,” in IEEE Journal of Solid-State Circuits, vol. 58, no. 1, pp. 216-226, January 2023, doi: 10.1109/JSSC.2022.3214170.
[3] A. Garofalo et al., “A 1.15 TOPS/W, 16-Cores Parallel Ultra-Low Power Cluster with 2b-to-32b Fully Flexible Bit-Precision and Vector Lockstep Execution Mode,” ESSCIRC 2021—IEEE 47th European Solid State Circuits Conference (ESSCIRC), Grenoble, France, 2021, pp. 267-270, doi: 10.1109/ESSCIRC53450.2021.9567767.
[4] S. Jain, L. Lin and M. Alioto, “Processor Energy-Performance Range Extension Beyond Voltage Scaling via Drop-In Methodologies,” in IEEE Journal of Solid-State Circuits, vol. 55, no. 10, pp. 2670-2679 October 2020, doi: 10.1109/JSSC.2020.3005778.
[5] G. Lallement, F. Abouzeid, J.-M. Daveau, P. Roche and J.-L. Autran, “A 1.1-pJ/cycle, 20-MHz, 0.42-V Temperature Compensated ARM Cortex-M0+ SoC With Adaptive Self Body-Biasing in FD-SOI,” in IEEE Solid-State Circuits Letters, vol. 1, no. 7, pp. 174-177, July 2018, doi: 10.1109/LSSC.2019.2897016.
[6] J. Lee et al., “A Self-Tuning IoT Processor Using Leakage-Ratio Measurement for Energy-Optimal Operation,” in IEEE Journal of Solid-State Circuits, vol. 55, no. 1, pp. 87-97, January 2020, doi: 10.1109/JSSC.2019.2939890.
[7] D. Bol et al., “SleepRunner: A 28-nm FDSOI ULP Cortex-M0 MCU With ULL SRAM and UFBR PVT Compensation for 2.6-3.6-μW/DMIPS 40-80-MHz Active Mode and 131-nW/KB Fully Retentive Deep-Sleep Mode,” in IEEE Journal of Solid-State Circuits, vol. 56, no. 7, pp. 2256-2269 July 2021, doi: 10.1109/JSSC.2021.3056219.

1. A reconfigurable processor comprising:
a pipelined processor and memory modules associated with the pipelined processor, the pipelined processor being configured to execute an instruction set in a multi-stage pipeline including an instruction fetch (IF) stage, an instruction decode (ID) stage and an execute (EX) stage,
wherein the pipelined processor is further adapted to perform each of the IF, ID and EX stages as two or more interleaved threads in a multi-thread mode and to share an IF pipeline output of the IF stage and/or an ID pipeline output of the ID stage between the two or more interleaved threads.

2. The reconfigurable processor of claim 1, further comprising bypass registers adapted to allow the pipelined processor to switch between performing the IF, ID and EX stages in a single-thread mode and performing the IF, ID and EX stages in the multi-thread mode.

3. The reconfigurable processor of claim 1, further comprising:
one or more further pipelined processors and further memory modules for each of the one or more further pipelined processors, each of the one or more further pipelined processors being configured to execute the instruction set in a further multi-stage pipeline including a further IF stage, a further ID stage and a further EX stage,
wherein the memory modules associated with the pipelined processor include an instruction memory (IMEM) module adapted to share an IMEM output of the pipelined processor with each of the one or more further pipelined processors for use in the further multi-stage pipeline.

4. The reconfigurable processor of claim 3, wherein the pipelined processor is further adapted to share the IF pipeline output of the IF stage as a further ID input to the further ID stage of each of the one or more further pipelined processors.

5. The reconfigurable processor of claim 3, wherein the pipelined processor is further adapted to share the ID pipeline output of the ID stage as a further EX input to the further EX stage of each of the one or more further pipelined processors.

6. The reconfigurable processor of claim 3, wherein the pipelined processor is further adapted to share the IF pipeline output of the IF stage as a further ID input to the further ID stage of each of the one or more further pipelined processors and to share the ID pipeline output of the ID stage as a further EX input to the further EX stage of each of the one or more further pipelined processors.

7. The reconfigurable processor of claim 3, further comprising systolic registers adapted to transfer data between the pipelined processor and the one or more further pipelined processors.

8. The reconfigurable processor of claim 3, further comprising an arithmetic logic unit (ALU) for each of the one or more further pipelined processors, the ALU being adapted to change a bit precision of a further EX stage output of the further EX stage.

9. The reconfigurable processor of claim 8, wherein the ALU is adapted to change the bit precision from 4 bits to 32 bits and vice versa.

10. The reconfigurable processor of claim 1, further comprising a watchdog unit adapted to monitor the pipelined processor for malfunctions or deadlock conditions.

11. A method of improving an efficiency of a reconfigurable processor, the reconfigurable processor having a pipelined processor and memory modules associated with the pipelined processor, the pipelined processor being configured to execute an instruction set in a multi-stage pipeline including an instruction fetch (IF) stage, an instruction decode (ID) stage and an execute (EX) stage, the method comprising:
performing each of the IF, ID and EX stages as two or more interleaved threads in a multi-thread mode; and
sharing an IF pipeline output of the IF stage and/or an ID pipeline output of the ID stage between the two or more interleaved threads.

12. The method of claim 11, wherein the reconfigurable processor further comprises bypass registers, the method further comprises using the bypass registers to switch the pipelined processor between performing the IF, ID and EX stages in a single-thread mode and performing the IF, ID and EX stages in the multi-thread mode.

13. The method of claim 11, wherein the reconfigurable processor further comprises one or more further pipelined processors and further memory modules for each of the one or more further pipelined processors, each of the one or more further pipelined processors being configured to execute the instruction set in a further multi-stage pipeline including a further IF stage, a further ID stage and a further EX stage, and wherein the memory modules associated with the pipelined processor include an instruction memory (IMEM) module, the method further comprises:
sharing an IMEM output of the IMEM module of the pipelined processor with each of the one or more further pipelined processors for use in the further multi-stage pipeline.

14. The method of claim 13, further comprising sharing the IF pipeline output of the IF stage of the pipelined processor as a further ID input to the further ID stage of each of the one or more further pipelined processors.

15. The method of claim 13, further comprising sharing the ID pipeline output of the ID stage of the pipelined processor as a further EX input to the further EX stage of each of the one or more further pipelined processors.

16. The method of claim 13, further comprising:
sharing the IF pipeline output of the IF stage of the pipelined processor as a further ID input to the further ID stage of each of the one or more further pipelined processors; and
sharing the ID pipeline output of the ID stage of the pipelined processor as a further EX input to the further EX stage of each of the one or more further pipelined processors.

17. The method of claim 13, wherein the reconfigurable processor further comprises systolic registers, the method further comprises transferring data between the pipelined processor and the one or more further pipelined processors using the systolic registers.

18. The method of claim 13, wherein the reconfigurable processor further comprises an arithmetic logic unit (ALU) for each of the one or more further pipelined processors, the method further comprises changing a bit precision of a further EX stage output of the further EX stage using the ALU.

19. The method of claim 18, wherein changing the bit precision of the further EX stage output comprises changing the bit precision from 4 bits to 32 bits and vice versa.

20. The method of claim 11, wherein the reconfigurable processor further comprises a watchdog unit, the method further comprises monitoring the pipelined processor for malfunctions or deadlock conditions using the watchdog unit.
